(19) United States
(12) Patent Application Publication
(10) Pub. No.: US 2017/0264128 A1
(43) Pub. Date: Sep. 14, 2017

(54) Wireless Electrical Charging System

(71) Applicant: Andrew Chen, Piscataway, NJ (US)

(72) Inventor: Andrew Chen, Piscataway, NJ (US)

(21) Appl. No.: 15/069,069

(22) Filed: Mar. 14, 2016

(51) Int. Cl. H02J 7/02; H02J 7/00; H02J 50/80; H02J 50/10

(52) U.S. Cl. CPC H02J 7/025; H02J 50/10; H02J 7/0052; H02J 50/80; H02J 7/0042; H02J 2007/0059

(57) ABSTRACT

A wireless electrical charging system includes a wireless communication unit that may emit a radio frequency signal. An induction unit is electrically coupled to a power source. The induction unit is in electrical communication with the wireless communication unit. The induction unit may communicate an electrical signal to the wireless communication unit. Thus, the radio frequency signal may carry the electrical signal. A receiving unit is in electrical communication with the wireless communication unit. Thus, the receiving unit may receive the electrical signal from the wireless communication unit. The receiving unit may be selectively electrically coupled to an extrinsic electronic device. Thus, the receiving unit may charge the extrinsic electronic device.

### BACKGROUND OF THE DISCLOSURE

### Field of the Disclosure

The disclosure relates to charging devices and more particularly pertains to a new charging device for wirelessly charging an electronic device.

### SUMMARY OF THE DISCLOSURE

An embodiment of the disclosure meets the needs presented above by generally comprising a wireless communication unit that may emit a radio frequency signal. An induction unit is electrically coupled to a power source. The induction unit is in electrical communication with the wireless communication unit. The induction unit may communicate an electrical signal to the wireless communication unit. Thus, the radio frequency signal may carry the electrical signal. A receiving unit is in electrical communication with the wireless communication unit. Thus, the receiving unit may receive the electrical signal from the wireless communication unit. The receiving unit may be selectively electrically coupled to an extrinsic electronic device. Thus, the receiving unit may charge the extrinsic electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a wireless electrical charging system according to an embodiment of the disclosure.

FIG. 2 is a perspective in-use view of an embodiment of the disclosure.

FIG. 3 is a schematic view of an embodiment of the disclosure.

### DESCRIPTION OF THE PREFERRED EMBODIMENT

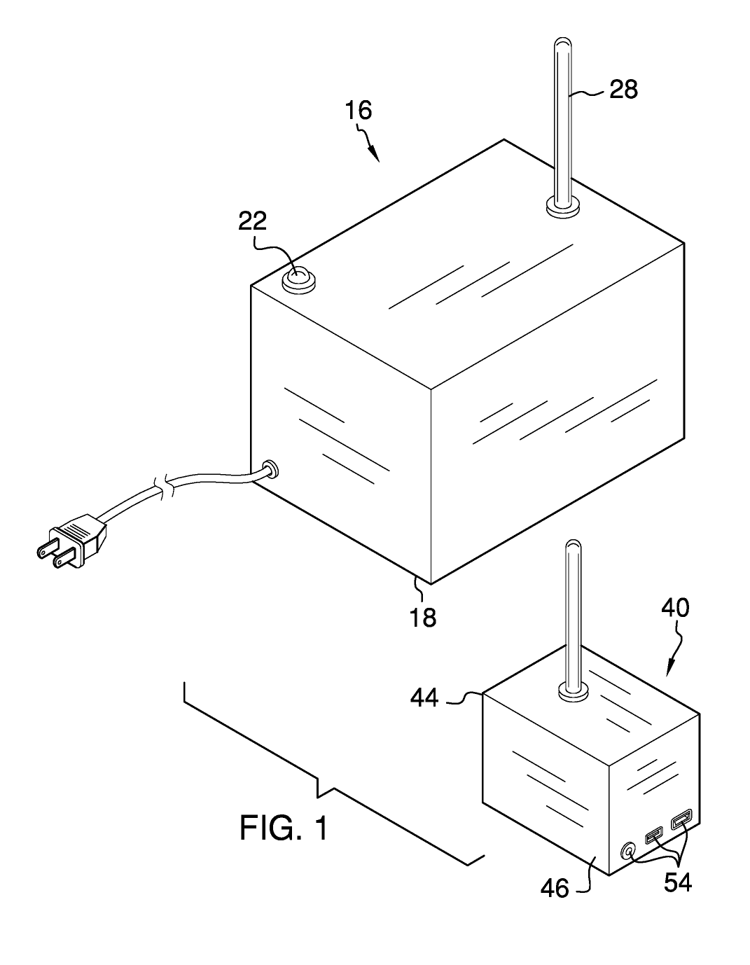

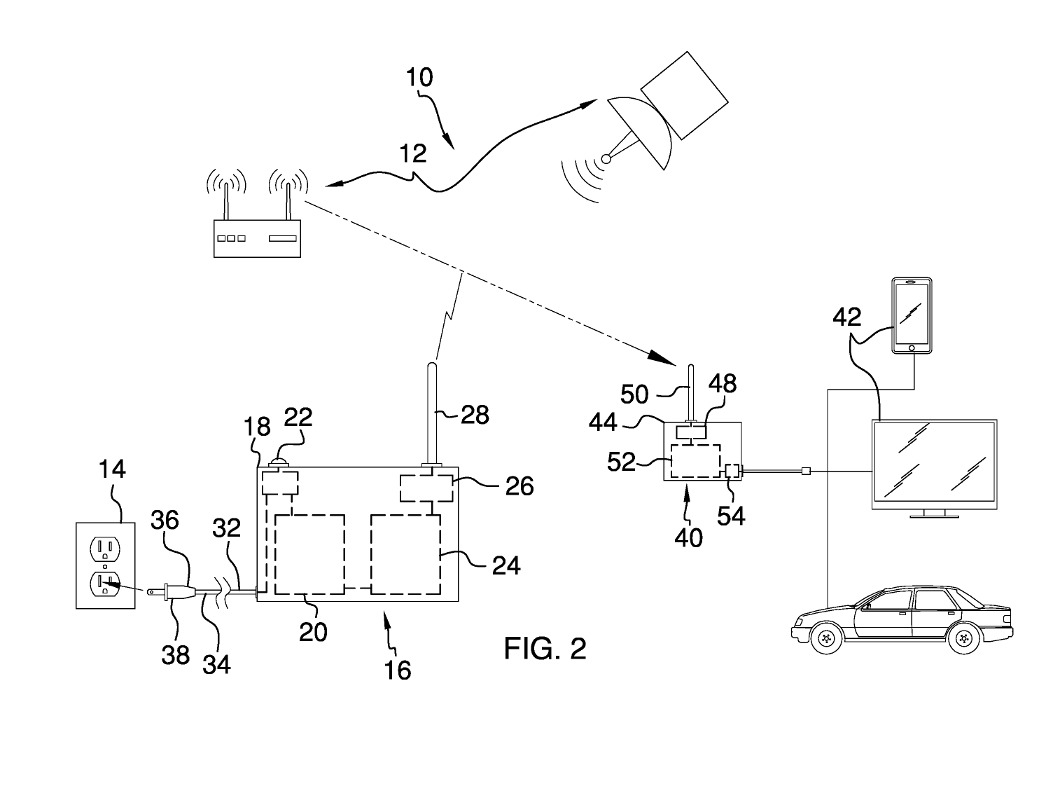

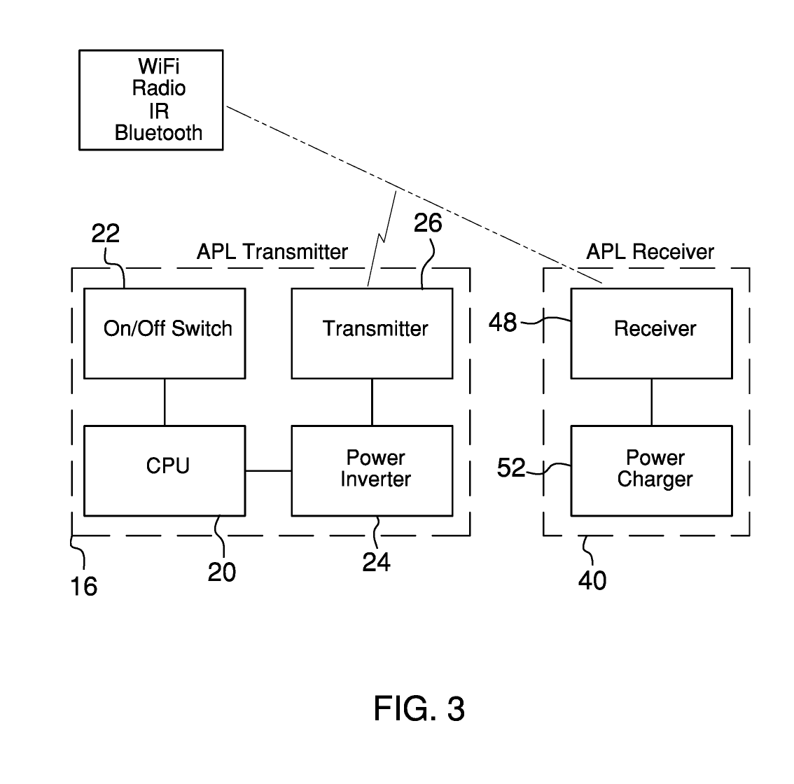

With reference now to the drawings, and in particular to FIGS. 1 through 3 thereof, a new charging device embodying the principles and concepts of an embodiment of the disclosure and generally designated by the reference numeral 10 will be described.

As best illustrated in FIGS. 1 through 3, the wireless electrical charging system 10 generally comprises a wireless communication unit 12. The wireless communication unit 12 emits a radio frequency signal. The wireless communication unit 12 may comprise a wifi router or the like. Additionally, the wireless communication unit 12 may comprise an earth orbiting satellite or the like.

A power source 14 is included. The power source 14 may comprise an electrical outlet or the like. An induction unit 16 is provided and the induction unit 16 is electrically coupled to the power source 14. The induction unit 16 is in electrical communication with the wireless communication unit 12. The induction unit 16 communicates an electrical signal to the wireless communication unit 12. Thus, the radio frequency signal may carry the electrical signal.

The induction unit 16 comprises a first housing 18 and a processor 20 that is positioned within the first housing 18. The processor 20 is electrically coupled to the power source 14. The processor 20 may comprise an electronic processor or the like. A switch 22 is coupled to the first housing 18 and the switch 22 may be manipulated. The switch 22 is electrically coupled to the processor 20 such that the switch 22 turns the processor 20 on and off.

An inverter 24 is positioned within the first housing 18 and the inverter 24 is electrically coupled to the processor 20. The inverter 24 converts an electrical current from the processor 20 into a wireless electrical signal. The inverter 24 may comprise a radiative induction device or the like. Moreover, the inverter 24 may employ far-field transmission technology or the like.

A transmitter 26 is positioned within the first housing 18. The transmitter 26 is electrically coupled to the inverter 24 to broadcast the wireless electrical signal. The transmitter 26 is in electrical communication with the wireless communication unit 12. Thus, the wireless communication unit 12 may broadcast the wireless electrical signal.

The transmitter 26 may be synched to the wireless communication unit 12 via Bluetooth protocol or the like. The transmitter 26 includes a first antenna 28 that is coupled to the first housing 18. The first antenna 28 is electrically coupled to the transmitter 26 to broadcast the wireless electrical signal. The transmitter 26 may comprise a radio frequency transmitter or the like.

A power supply 32 is electrically coupled to the switch 22. The power supply 32 comprises a power cord 34 extending outwardly from the first housing 18. The power cord 34 has a distal end 36 with respect to the first housing 18 and a plug 38 is electrically coupled to the distal end 36. The plug 38 is selectively electrically coupled to the power source 14.

A receiving unit 40 is provided. The receiving unit 40 is in electrical communication with the wireless communication unit 12. Thus, the receiving unit 40 receives the electrical signal from the wireless communication unit 12. The receiving unit 40 may be selectively electrically coupled to an extrinsic electronic device 42. Thus, the receiving unit 40 may charge the extrinsic electronic device 42. The extrinsic electronic device 42 may comprise a Smart phone, a laptop computer or other extrinsic electronic device 42 that includes a rechargeable battery.

The receiving unit 40 comprises a second housing 44 and the second housing 44 has an outer wall 46. A receiver 48 is positioned within the second housing 44 and the receiver 48 is in electrical communication with the wireless communication unit 12. Thus, the receiver 48 may receive the wireless electrical signal from the wireless communication unit 12. The receiver 48 includes a second antenna 50 that is coupled to the second housing 44. The second antenna 50 is electrically coupled to the receiver 48 to receive the wireless electrical signal.

A charger 52 is positioned within the second housing 50. The charger 52 is electrically coupled to the receiver 48. Thus, the charger 52 may receive the wireless electrical signal. The charger 52 may comprise a battery charger or the like.

A plurality of charge ports 54 is provided. Each of the charge ports 54 is coupled to the outer wall 46 of the second housing 50. Thus, each of the charge ports 54 may be selectively electrically coupled to the extrinsic electronic device 42. Each of the charge ports 54 is electrically coupled to the charger 52. Thus, the charge ports 54 may charge the extrinsic electronic device 42. The plurality of charge ports 54 may include a usb port, a ¼ inch plug or other conventional charge port.

In use, the power cord 54 is electrically coupled to the power source 14. The switch 22 is manipulated to turn the processor 20 on. Thus, the transmitter 26 is placed in electrical communication with the wireless communication unit 12. The transmitter 26 communicates the wireless electrical signal the wireless communication unit 12. Thus, the wireless communication unit 12 broadcasts the wireless electrical signal. The receiver 48 receives the wireless electrical signal from the wireless communication unit 12. The extrinsic electronic device 42 is electrically coupled to a selected one of the charge ports 54. Thus, the extrinsic electronic device 42 is wirelessly charged with respect to the power source. 14

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A wireless electrical charging system comprising:
a wireless communication unit being configured to emit a radio frequency signal;
a power source;
an induction unit being electrically coupled to said power source, said induction unit being in electrical communication with said wireless communication unit wherein said induction unit is configured communicate an electrical signal to said wireless communication unit thereby facilitating the radio frequency signal to carry the electrical signal; and
a receiving unit being in electrical communication with said wireless communication unit wherein said receiving unit is configured to receive the electrical signal from said wireless communication unit, said receiving unit being configured to be selectively electrically coupled to an extrinsic electronic device thereby facilitating said receiving unit to charge the extrinsic electronic device.

2. The system according to claim 1, wherein said induction unit comprises:
a first housing;
a processor being positioned within said first housing, said processor being electrically coupled to said power source; and
a switch being coupled to said housing wherein said switch is configured to be manipulated, said switch being electrically coupled to said processor such that said switch turns said processor on and off.

3. The system according to claim 2, further comprising an inverter being positioned within said first housing, said inverter being electrically coupled to said processor, said inverter being configured to convert an electrical current from said processor into a wireless electrical signal.

4. The system according to claim 3, further comprising a transmitter being positioned within said first housing, said transmitter being electrically coupled to said inverter wherein said transmitter is configured to broadcast the wireless electrical signal, said transmitter being in electrical communication with said wireless communication unit wherein said wireless communication unit is configured to broadcast the wireless electrical signal, said transmitter including a first antenna being coupled to said first housing, said first antenna being electrically coupled to said transmitter wherein said antenna is configured to broadcast the wireless electrical signal.

5. The system according to claim 2, further comprising a power supply being electrically coupled to said switch, said power supply comprising a power cord extending outwardly from said first housing, said power cord having a distal end with respect to said first housing, said distal end having a plug being electrically coupled thereto, said plug being selectively electrically coupled to said power source.

6. The system according to claim 1, wherein said receiving unit comprises:
a second housing, said second housing having an outer wall; and
a receiver being positioned within said second housing, said receiver being in electrical communication with said wireless communication unit wherein said receiver is configured to receive a wireless electrical signal from said wireless communication unit, said receiver including a second antenna being coupled to said second housing, said second antenna being electrically coupled to said receiver wherein said second antenna is configured to receive the wireless electrical signal.

7. The system according to claim 6, further comprising a charger being positioned within said second housing, said charger being electrically coupled to said receiver wherein said charger is configured to receive the wireless electrical signal.

8. The system according to claim 7, further comprising a plurality of charge ports, each of said charge ports being coupled to said outer wall of said second housing wherein a each of said charge ports is configured to be selectively electrically coupled to the extrinsic electronic device, each of said charge ports being electrically coupled to said charger wherein said charge ports are configured to charge the extrinsic electronic device.

9. A wireless electrical charging system comprising:
a wireless communication unit being configured to emit a radio frequency signal;
a power source;
an induction unit being electrically coupled to said power source, said induction unit being in electrical communication with said wireless communication unit wherein said induction unit is configured communicate an electrical signal to said wireless communication unit thereby facilitating the radio frequency signal to carry the electrical signal, said induction unit comprising:
a first housing,
a processor being positioned within said first housing, said processor being electrically coupled to said power source,
a switch being coupled to said housing wherein said switch is configured to be manipulated, said switch being electrically coupled to said processor such that said switch turns said processor on and off,
an inverter being positioned within said first housing, said inverter being electrically coupled to said processor, said inverter being configured to convert an electrical current from said processor into a wireless electrical signal,
a transmitter being positioned within said first housing, said transmitter being electrically coupled to said inverter wherein said transmitter is configured to broadcast the wireless electrical signal, said transmitter being in electrical communication with said wireless communication unit wherein said wireless communication unit is configured to broadcast the wireless electrical signal, said transmitter including a first antenna being coupled to said first housing, said first antenna being electrically coupled to said transmitter wherein said antenna is configured to broadcast the wireless electrical signal, and
a power supply being electrically coupled to said switch, said power supply comprising a power cord extending outwardly from said first housing, said power cord having a distal end with respect to said first housing, said distal end having a plug being electrically coupled thereto, said plug being selectively electrically coupled to said power source; and
a receiving unit being in electrical communication with said wireless communication unit wherein said receiving unit is configured to receive the electrical signal from said wireless communication unit, said receiving unit being configured to be selectively electrically coupled to an extrinsic electronic device thereby facilitating said receiving unit to charge the extrinsic electronic device, said receiving unit comprising:
a second housing, said second housing having an outer wall,
a receiver being positioned within said second housing, said receiver being in electrical communication with said wireless communication unit wherein said receiver is configured to receive the wireless electrical signal from said wireless communication unit, said receiver including a second antenna being coupled to said second housing, said second antenna being electrically coupled to said receiver wherein said second antenna is configured to receive the wireless electrical signal,
a charger being positioned within said second housing, said charger being electrically coupled to said receiver wherein said charger is configured to receive the wireless electrical signal, and
a plurality of charge ports, each of said charge ports being coupled to said outer wall of said second housing wherein a each of said charge ports is configured to be selectively electrically coupled to the extrinsic electronic device, each of said charge ports being electrically coupled to said charger wherein said charge ports are configured to charge the extrinsic electronic device.
